(19) United States
(12) Patent Application Publication
(10) Pub. No.: US 2024/0026203 A1
(43) Pub. Date: Jan. 25, 2024

(54) THERMAL INTERFACE COMPOSITION AND THERMAL INTERFACE MATERIAL

(71) Applicant: Panasonic Intellectual Property Management Co., Ltd., Osaka (JP)

(72) Inventor: Asahi KASUE, Osaka (JP)

(21) Appl. No.: 18/481,810

(22) Filed: Oct. 5, 2023

Related U.S. Application Data
(63) Continuation of application No. PCT/JP2022/019253, filed on Apr. 28, 2022.

(30) Foreign Application Priority Data
Apr. 28, 2021 (JP) 2021-076772

(51) Int. Cl. C09K 5/14; C08K 7/18; C08K 3/04; C08K 9/02

(52) U.S. Cl. CPC C09K 5/14; C08K 7/18; C08K 3/042; C08K 9/02

(57) ABSTRACT

The present disclosure provides a thermal interface composition that allows a thermal interface material with high thermal conductivity to be formed and that has good moldability. A thermal interface composition according to the present disclosure includes: a resin (A); and a carbon-based material (B) having a surface coated with an inorganic substance.

### CROSS-REFERENCE TO RELATED APPLICATIONS

The present application is a Bypass Continuation of International Application No. PCT/JP2022/019253 filed on Apr. 28, 2022, which is based upon, and claims the benefit of priority to, Japanese Patent Application No. 2021-076772, filed on Apr. 28, 2021. The entire contents of both applications are hereby incorporated by reference.

### TECHNICAL FIELD

The present disclosure generally relates to a thermal interface composition and a thermal interface material. More particularly, the present disclosure relates to a thermal interface composition containing a thermally conductive filler and a thermal interface material formed out of the thermal interface composition.

### BACKGROUND ART

The heat generated by an electronic or electrical component is transferred to a heat dissipator (heat sink) by interposing a thermal interface material between an electrical component such as a transistor or a central processing unit (CPU) of a computer and the heat dissipator.

JP 2019-131668 A discloses a heat-dissipating resin composition including, in combination, an epoxy resin, metal oxide particles, and a cationic curing agent.

### SUMMARY

The present disclosure provides a thermal interface composition that allows a thermal interface material with high thermal conductivity to be formed and that has good moldability and also provides a thermal interface material formed out of such a thermal interface composition.

A thermal interface composition according to an aspect of the present disclosure includes a resin (A) and a carbon-based material (B) having a surface coated with an inorganic substance.

A thermal interface material according to another aspect of the present disclosure is formed by molding the thermal interface composition described above into a film shape or a sheet shape.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1 is a schematic cross-sectional view of an electronic device including a thermal interface material according to an exemplary embodiment of the present disclosure.

### DETAILED DESCRIPTION

The present inventors discovered, as a result of research, that the heat dissipating resin composition that uses an epoxy resin as disclosed in JP 2019-131668 A includes so large a number of metal oxide particles as a thermally conductive filler that a cured product of the epoxy resin tends to be too hard and brittle. In addition, the resin composition of JP 2019-131668 A includes so large a number of metal oxide particles that curing of the epoxy resin is often impeded by the metal oxide particles, thus frequently causing a decline in bonding strength.

Thus, the present inventors tried using a carbon-based material as the thermally conductive filler. Although carbon-based materials have high thermal conductivity, practical thermal interface materials containing carbon-based materials have not been sufficiently researched yet.

The present inventors also discovered that using a carbon-based material as a thermally conductive filler caused inconveniences such as insufficient dispersion of the carbon-based material in the resin and a decrease in the curability of the resin.

To overcome this problem, the present inventors carried out extensive research and development to provide a thermal interface composition that allows a thermal interface material (TIM) to be formed with high thermal conductivity and that has good moldability. As a result, the present inventors successfully conceived the concept of the present disclosure.

Note that although the present inventors conceived the concept of the present disclosure in this manner, this progress is only an example and should not construed as limiting the present disclosure.

### 1. Overview

An exemplary embodiment of the present disclosure will now be described.

A thermal interface composition according to this embodiment (hereinafter sometimes referred to as “thermal interface composition (X)”) includes: a resin (A); and a carbon-based material (B) having a surface coated with an inorganic substance.

According to this embodiment, the thermal conductivity of a thermal interface material formed out of the thermal interface composition (X) is increased by the carbon-based material (B). This allows, even if the content of a filler in the thermal interface composition is decreased to a low level to prevent the thermal interface material from becoming hard and brittle, the thermal interface material to have high thermal conductivity. In addition, the carbon-based material (B) is coated with an inorganic substance, and therefore, is easily dispersed in the resin (A), and is unlikely to inhibit curing of the resin (A). This reduces the chances of the carbon-based material (B) causing a decline in the moldability of the thermal interface composition (X).

Consequently, this embodiment allows a thermal interface material with high thermal conductivity to be formed out of the thermal interface composition and improves the moldability of the thermal interface composition significantly.

### 2. Details

Next, a thermal interface composition (X) according to this embodiment will be described in further detail.

As described above, the thermal interface composition (X) according to this embodiment includes: a resin (A); and a carbon-based material (B) having a surface coated with an inorganic substance.

The resin (A) preferably has reaction curability. The resin (A) may include, for example, a thermosetting resin. The resin (A) preferably includes at least one selected from the group consisting of epoxy resins, acrylic compounds, and silicone resins. This makes the thermal interface composition (X) usable as a heat dissipating adhesive with high bonding strength. Also, this imparts good heat resistance and flexibility to the thermal interface material formed out of the thermal interface composition (X). Note that the resin (A) as used herein may include any one of a monomer and a prepolymer as materials for a polymer and the polymer.

Normally, if the resin (A) contains a compound with polarity such as an acrylic compound, then a carbon-based material such as a graphite, a graphene, or a carbon nanotube is not easily dispersed in the resin (A). This is probably because the acrylic compound has polarity, whereas none of these carbon-based materials has polarity. In addition, if the resin (A) includes a silicone resin, then curing of the silicone resin is often inhibited.

However, the carbon-based material (B) according to this embodiment has its surface coated with an inorganic substance. This allows, even if the resin (A) contains a compound with polarity such as an acrylic compound, the carbon-based material (B) to be dispersed easily into the resin (A). Besides, this also reduces, even if the resin (A) includes a silicone resin, the chances of the carbon-based material (B) inhibiting curing of the silicone resin.

If the resin (A) includes an epoxy resin, the epoxy resin includes at least one selected from the group consisting of, for example, bisphenol A epoxy resins, bisphenol F epoxy resins, glycidylamine epoxy resins, cresol-novolac epoxy resins, and naphthalene epoxy resins.

If the resin (A) includes an epoxy resin, the thermal interface composition (X) may contain a curing agent. Examples of curing agents include phenol-based curing agents and dicyandiamide curing agents. The thermal interface composition (X) may further contain a curing accelerator as needed. Examples of curing accelerators include imidazoles, phenolic compounds, amines, and organic phosphines.

If the resin (A) includes a silicone resin, the silicone resin may be, for example, a reaction-curable liquid silicone rubber or silicone gel. The silicone resin may be of a two-component type or a one-component type, whichever is appropriate. The silicone resin contains a reactive organosilicon compound such as organo polysiloxane, a curing agent, and, if necessary, a catalyst. The curing agent contains, for example, at least one of organo hydrogen polysiloxane or an organic peroxide. The catalyst may be, for example, a platinum-based catalyst. Note that these are only exemplary components that may be contained in the silicone resin and should not be construed as limiting.

If the resin (A) contains an acrylic compound, the acrylic compound has at least one of an acryloyl group or a methacryloyl group in its molecule. The acrylic compound contains at least one selected from the group consisting of, for example, alkyl acrylates such as lauryl acrylate, phenoxy diethylene glycol acrylate, methoxy polyethylene glycol acrylate, and esters of acrylic acid polymers.

The carbon-based material (B) has excellent thermal conductivity. This allows the carbon-based material (B) to effectively reduce the thermal resistance of the thermal interface composition (X). The carbon-based material (B) preferably includes at least one selected from the group consisting of a spherical graphite, a plate graphite, a single-layer graphene, a multilayer graphene, a multilayer carbon nanotube, and a single-layer carbon nanotube.

If the carbon-based material (B) contain a spherical graphite, for example, the spherical graphite preferably has a mean particle size equal to or greater than 10 μm and equal to or less than 200 μm. Making the mean particle size of the spherical graphite equal to or greater than 10 μm allows the thermal interface composition (X) to have sufficient thermal conductivity. Making the mean particle size of the spherical graphite equal to or less than 200 μm allows the thermal interface composition to have sufficient flowability. In particular, it is preferable that the spherical graphite include two or more groups of particles having mutually different mean particle sizes. This allows the thermal interface composition (X) to have not only sufficient thermal conductivity but also sufficient flowability as well. The spherical graphite more preferably has a mean particle size equal to or greater than 40 μm and equal to or less than 100 μm. Note that the mean particle size of the spherical graphite is a median diameter (D50) calculated based on a particle size distribution obtained by a particle size distribution measuring method such as the laser diffraction/scattering method.

As described above, the surface of the carbon-based material (B) is coated with an inorganic substance. The inorganic substance contains, for example, at least one selected from the group consisting of metals and metal compounds, and specifically contains at least one selected from the group consisting of, for example, silver, nickel, magnesium, magnesium carbonate, anhydrous magnesium carbonate, and magnesium hydroxide. More preferably, the inorganic substance contains a metal.

As used herein, the expression “the surface of the carbon-based material (B) is coated with an inorganic substance” refers to not only a situation where the surface of the particles of the carbon-based material (B) is coated with the inorganic substance entirely but also a situation where the inorganic substance adheres to a major region of the surface of the particles of the carbon-based material (B) to make the carbon-based material (B) partially exposed.

The proportion by volume of the carbon-based material (B) to the total solid content of the thermal interface composition (X) is preferably equal to or greater than 40% by volume and equal to or less than 80% by volume. Making the proportion of the carbon-based material (B) equal to or greater than 40% by volume allows the thermal interface composition (X) to have sufficient thermal conductivity. Making the proportion of the carbon-based material (B) equal to or less than 80% by volume allows the thermal interface composition (X) to have sufficient flowability. The proportion by volume of the carbon-based material (B) to the total solid content of the thermal interface composition (X) is more preferably equal to or greater than 50% by volume and equal to or less than 70% by volume and is even more preferably equal to or greater than 55% by volume and equal to or less than 65% by volume.

The carbon-based material (B) includes a first carbon-based material (B1) and a second carbon-based material (B2) and the aspect ratio of the second carbon-based material (B2) is preferably larger than the aspect ratio of the first carbon-based material (B1). The thermal conductivity of the thermal interface composition (X) may be increased particularly significantly according to the combination of the first carbon-based material (B1) and the second carbon-based material (B2). This is probably because the second carbon-based material (B2) with the larger aspect ratio would form a path for heat transfer in the thermal interface composition (X). In addition, the second carbon-based material (B2) with the larger aspect ratio usually increases the viscosity of the thermal interface composition (X). However, using the first carbon-based material (B1) and the second carbon-based material (B2) in combination may reduce the chances of increasing the viscosity of the thermal interface composition (X) excessively. Note that the aspect ratio may be measured in the following manner, for example. Specifically, 100 images representing particles of the first carbon-based material (B1) and 100 images representing particles of the second carbon-based material (B2) are extracted and shot through an electron microscope. Based on these particle images, the major- and minor-axis sizes of the particles are measured. In this case, a dimension with the longest width in each particle image is supposed to be the major-axis size and a dimension with the shortest width in each particle image is supposed to be the minor-axis size. The major- and minor-axis sizes are measured with respect to the 100 particles and their averages are calculated. Based on these results, the aspect ratio is calculated as the ratio of the average major-axis size to the average minor-axis size.

The first carbon-based material (B1) preferably has an aspect ratio equal to or greater than 1 and equal to or less than 2. Making the aspect ratio of the first carbon-based material (B1) equal to or less than 2 increases the chances of the thermal interface composition (X) having sufficient flowability. The first carbon-based material (B1) more preferably has an aspect ratio equal to or less than 1.5 and even more preferably has an aspect ratio equal to or less than 1.2.

The first carbon-based material (B1) preferably contains a spherical graphite. The spherical graphite has so small an aspect ratio that adding the spherical graphite to the first carbon-based material (B1) allows the carbon-based material (B) to be dispersed in the thermal interface composition (X) more uniformly. In addition, this also prevents the thermal interface composition (X) from having an excessively increased viscosity and allows the thermal interface composition (X) to have sufficient flowability.

The spherical graphite contained in the first carbon-based material (B1) preferably has a mean particle size equal to or greater than 10 μm and equal to or less than 200 μm. Making the mean particle size of the spherical graphite equal to or greater than 10 μm may increase the thermal conductivity of the thermal interface composition (X). Making the mean particle size of the spherical graphite equal to or less than 200 μm prevents the thermal interface composition (X) from having an excessively increased viscosity. The spherical graphite having a mean particle size equal to or greater than 10 μm and equal to or less than 200 μm may include two or more groups of particles with mutually different mean particle sizes. The spherical graphite more preferably has a mean particle size equal to or greater than 40 μm and even more preferably has a mean particle size equal to or greater than 80 μm. Meanwhile, the mean particle size is more preferably equal to or less than 100 μm. Note that the mean particle size of the spherical graphite is a median diameter (D50) calculated based on a particle size distribution obtained by a particle size distribution measuring method such as the laser diffraction/scattering method.

The second carbon-based material (B2) preferably includes at least one selected from the group consisting of a plate graphite, a single-layer graphene, a multilayer graphene, a multilayer carbon nanotube, and a single-layer carbon nanotube. This allows the second carbon-based material (B2) to have particularly high thermal conductivity, thus enabling increasing the thermal conductivity of the thermal interface composition (X) effectively. The multilayer graphene is made up of a plurality of single graphene layers. The number of the single graphene layers stacked in the multilayer graphene is preferably equal to or less than 30 or the multilayer graphene preferably has a thickness equal to or less than 30 nm.

The second carbon-based material (B2) preferably has an aspect ratio equal to or greater than 3 and equal to or less than 1200. Making the aspect ratio of the second carbon-based material (B2) equal to or greater than 3 allows the second carbon-based material (B2) to form a heat transfer path in the thermal interface composition (X), thus enabling increasing the thermal conductivity of the thermal interface composition (X). Making the aspect ratio of the second carbon-based material (B2) equal to or less than 1200 allows the thermal interface composition (X) to have sufficient flowability.

If the second carbon-based material (B2) includes at least one selected from the group consisting of a plate graphite, a single-layer graphene, a multilayer graphene, a multilayer carbon nanotube, and a single-layer carbon nanotube, then the mean particle size thereof is preferably equal to or greater than 1 μm and equal to or less than 60 μm. Note that the mean particle size of the second carbon-based material (B2) is a median diameter (D50) calculated based on a particle size distribution obtained by a particle image analysis system.

The proportion by volume of the first carbon-based material (B1) to the total of the thermal interface composition (X) is preferably equal to or greater than 1% by volume and equal to or less than 90% by volume. Making the proportion by volume of the first carbon-based material (B1) equal to or greater than 1% by volume of the total of the thermal interface composition (X) reduces the chances of the second carbon-based material (B2) increasing the viscosity of the thermal interface composition (X) excessively. Making the proportion by volume of the first carbon-based material (B1) equal to or less than 90% by volume of the total of the thermal interface composition (X) allows the thermal interface composition (X) to contain the second carbon-based material (B2), thus enabling increasing the thermal conductivity of the thermal interface composition (X). The proportion by volume of the first carbon-based material (B1) to the total of the thermal interface composition (X) is more preferably equal to or greater than 60% by volume and equal to or less than 80% by volume and even more preferably equal to or greater than 65% by volume and equal to or less than 75% by volume.

The proportion by volume of the second carbon-based material (B2) to the total of the thermal interface composition (X) is preferably equal to or greater than 0.1% by volume and equal to or less than 30% by volume. Making the proportion by volume of the second carbon-based material (B2) equal to or greater than 0.1% by volume of the total of the thermal interface composition (X) further increases the thermal conductivity of the thermal interface composition (X). Making the proportion by volume of the second carbon-based material (B2) equal to or less than 30% by volume of the total of the thermal interface composition (X) further reduces the chances of increasing the viscosity of the thermal interface composition (X) excessively. The proportion by volume of the second carbon-based material (B2) to the total of the thermal interface composition (X) is more preferably equal to or greater than 1% by volume and equal to or less than 10% by volume and even more preferably equal to or greater than 2% by volume and equal to or less than 5% by volume.

The proportion of the first carbon-based material (B1) to the total of the thermal interface composition (X) is preferably larger than the proportion of the second carbon-based material (B2) to the total of the thermal interface composition (X). Increasing the proportion of the first carbon-based material (B1) having the smaller aspect ratio not only reduces the chances of increasing the viscosity of the thermal interface composition (X) excessively but also increases the thermal conductivity of the thermal interface composition (X) as well. The ratio by volume of the first carbon-based material (B1) to the second carbon-based material (B2) preferably falls within the range from 29:1 to 9:1, more preferably falls within the range from 19:1 to 10:1, and even more preferably falls within the range from 15:1 to 12:1.

The thermal interface composition (X) preferably further contains an inorganic filler (C) other than the carbon-based materials (B). The carbon-based material (B) tends to increase the viscosity of the thermal interface composition (X), but the inorganic filler (C) is less likely to increase the viscosity of the thermal interface composition (X) than the carbon-based material (B) does. That is to say, using the carbon-based material (B) and the inorganic filler (C) in combination particularly significantly reduces an excessive increase in the viscosity of the thermal interface composition (X). Specific examples of the inorganic filler (C) include, without limitation, spherical alumina.

The inorganic filler (C) preferably has a mean particle size equal to or greater than 0.1 μm and equal to or less than 10 μm. Adding not only the carbon-based material (B) but also the inorganic filler (C) having a mean particle size falling within this range to the thermal interface composition (X) makes it even easier to increase the thermal conductivity of the thermal interface composition (X). The reason is not completely clear at this time but probably allowing both the carbon-based material (B) and the inorganic filler (C) to have adequate size distributions would make it easier to form a heat transfer path in the thermal interface composition (X). Optionally, the inorganic filler (C) may include two or more groups of particles having mutually different mean particle sizes that fall within the above-specified range. The mean particle size of the inorganic filler (C) is more preferably equal to or greater than 0.2 μm and equal to or less than 5 μm, and even more preferably equal to or greater than 0.4 μm and equal to or less than 1 μm. Note that the mean particle size of the inorganic filler (C) is a median diameter (D50) calculated based on a particle size distribution obtained by a particle size distribution measuring method such as the laser diffraction method.

The thermal interface composition (X) may further contain a dispersant (D). Adding a dispersant (D) to the thermal interface composition (X) allows the carbon-based materials (B) and the inorganic filler (C) to be dispersed more uniformly in the resin (A).

The thermal interface composition (X) is preferably liquid at 25° C. The thermal interface composition (X) preferably has a viscosity equal to or less than 3000 Pa·s at 25° C. This allows the thermal interface composition (X) to have good moldability. For example, this makes it easier to form the thermal interface composition (X) into a film shape using a dispenser, for example. In addition, this also makes it easier to defoam the thermal interface composition (X), thus reducing the chances of producing voids in the thermal interface composition (X). Note that the viscosity is a value measured by using an E-type rotational viscometer under the condition including 0.3 rpm.

The thermal interface composition (X) may be prepared by, for example, kneading the above-described components together. If the thermal interface composition (X) contains a silicone resin as a two-part component, then a thermal interface composition (X), consisting of a first component, including a reactive organic silicon compound, of the silicone resin and a second component, including a curing agent, of the silicone resin, may be prepared. The first component and the second component may be mixed together when the thermal interface composition (X) is used. In that case, the carbon-based material (B) may be contained in at least one of the first component or the second component.

The thermal interface material is formed by, for example, molding the thermal interface composition into either a film shape or a sheet shape. If the thermal interface material is formed out of the thermal interface composition (X), the thermal interface composition (X) is molded into a film shape or a sheet shape by an appropriate method such as press molding, extrusion, or calendar molding. It is also preferable that the thermal interface composition (X) be molded into a film shape or a sheet shape using a dispenser. If the thermal interface composition (X) contains a thermosetting resin, the film of the thermal interface composition (X) is subsequently heated under a condition according to its chemical makeup and thereby cured. In this manner, a film of the thermal interface material may be obtained.

Note that the thermal interface composition (X) and the thermal interface material do not have to be molded into a film or sheet shape but may also be molded into any other appropriate shape. Also, if the resin (A) is curable at an ordinary temperature, then the thermal interface material may also be obtained by curing the thermal interface composition (X) without heating the thermal interface composition (X). The thermal interface material includes: a resin matrix formed out of the resin (A); and the carbon-based material (B) dispersed in the resin matrix.

The thermal interface material contains the carbon-based material (B), and therefore, tends to have low thermal resistance. This is probably because the carbon-based material (B) has high thermal conductivity as described above. If the thermal interface material contains the first carbon-based material (B1) and the second carbon-based material (B2), then the thermal interface material tends to have even lower thermal resistance. This is probably because the second carbon-based material (B2) having the larger aspect ratio would form a heat transfer path in the thermal interface material as described above.

The thermal interface material preferably has a thermal resistance equal to or less than 1.5 K/W in the thickness direction under no pressure. This allows the thermal interface material to express excellent thermal conductivity and transfer heat efficiently. The thermal resistance is more preferably equal to or less than 1.0 K/W and is even more preferably equal to or less than 0.8 K/W.

The thermal interface material preferably has an Asker C hardness equal to or less than The Asker C hardness may be measured with, for example, an Asker rubber hardness meter (durometer) type C manufactured by Kobunshi Keiki Co., Ltd. If the Asker C hardness is equal to or less than 40, the thermal interface material may have sufficient flexibility. This makes it easier to adhere the thermal interface material closely to a surface having any of various shapes such as a warped surface or a wavy surface. The Asker C hardness is more preferably equal to or less than 30. Meanwhile, the Asker C hardness may be, for example, equal to or greater than Such a low Asker C hardness is achievable by, for example, selecting an appropriate resin (A), selecting appropriate aspect ratios for the first carbon-based material (B1) and the second carbon-based material (B2), or selecting appropriate proportions for the first carbon-based material (B1) and the second carbon-based material (B2).

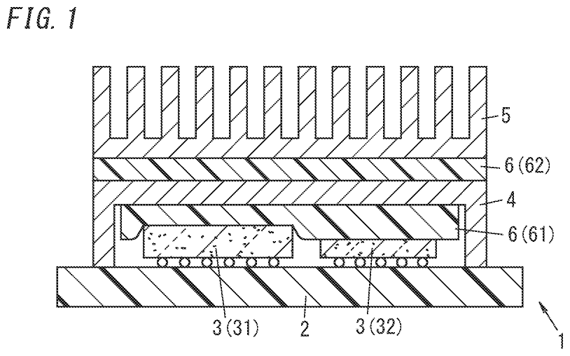

Next, an exemplary electronic device including the thermal interface material will be described. The electronic device 1 shown in FIG. 1 includes a board 2, a chip component 3, a heat spreader 4, a heatsink 5, and two types of thermal interface materials 6 (hereinafter referred to as a “first thermal interface material 61” and a “second thermal interface material 62,” respectively). The chip component 3 is mounted on the board 2. The board 2 may be, for example, a printed wiring board. The chip component 3 may be, but do not have to be, a transistor, a CPU, an MPU, a driver IC, or a memory. A plurality of chip components 3 may be mounted on the board 2. In that case, the chip components 3 may have mutually different thicknesses. The heat spreader 4 is mounted on the board 2 to cover the chip components 3. A gap is left between the chip components 3 and the heat spreader 4. The first thermal interface material 61 is disposed to fill the gap. The heatsink 5 is disposed over the heat spreader 4 and the second thermal interface material 62 is interposed between the heat spreader 4 and the heatsink 5.

The thermal interface material according to this embodiment is applicable to any of the first thermal interface material 61 or the second thermal interface material 62. The thermal interface material according to this embodiment has such a low thermal resistance that the thermal interface material may transfer the heat generated by the chip components 3 to the heat spreader 4 and the heat sink 5 efficiently, thus making it easier to provide an electronic device 1 with good heat dissipation capability.

### EXAMPLES

Next, more specific examples of this embodiment will be described. Note that the specific examples to be described below are only examples of this embodiment and should not be construed as limiting.

### 1. Preparation of Thermal Interface Composition (X)

Thermal interface compositions (X) were prepared by using the following materials as materials for thermal interface compositions (X) representing respective examples and comparative examples and mixing those materials together at the proportions shown in Tables 1 and 2:
Epoxy resin 1: epoxy resin manufactured by DIC Corporation, product number EPICLON 830S;
Epoxy resin 2: epoxy resin manufactured by Mitsubishi Chemical Corporation, product number YX7400;
Curing agent 1: phenolic curing agent manufactured by Meiwa Plastic Industries, Ltd., product number MEH-8000H;
Curing agent 2: phenolic curing agent manufactured by Gun Ei Chemical Industry Co., Ltd., product number ELPC75;
Curing accelerator: imidazole-based curing accelerator “CUREZOL” manufactured by Shikoku Chemicals Corporation, product number 2E4MZ;
Acrylic compound A: acrylic compound manufactured by Kao Corporation, product number EXCEPARL L-MA;
Acrylic compound B: acrylic compound manufactured by Shin-Nakamura Chemical Co., Ltd., product number AMP-20GY;
Cross-linking agent: polyfunctional thiol manufactured by Showa Denko K.K., product number Karenz PE1;
Radical initiator: product number VAm-110 (2,2′-azobis(N-butyl-2-methylpropionamide) manufactured by FUJIFILM Wako Pure Chemical Corporation;
Silicone resin: two-component silicone resin manufactured by Dow Toray Co., Ltd., product number SE1885;
Coupling agent A: silane coupling agent manufactured by Shin-Etsu Chemical Co., Ltd., product name KBM-503;
Coupling agent B: silane coupling agent manufactured by Dow Toray Co., Ltd., product name Z-6583;
Dispersant: wet dispersant for ceramics and metallic materials manufactured by NOF Corporation, product name MALIALIM SC0505K;
Surface-coated spherical graphite 1: graphite formed by surface-coating a spherical graphite manufactured by Ito Graphite Co., Ltd. with silver and nickel, having a mean particle size of 40 μm and an aspect ratio of 1.5;
Surface-coated spherical graphite 2: graphite formed by surface-coating the spherical graphite manufactured by Ito Graphite Co., Ltd. with magnesium carbonate, having a mean particle size of 40 μm and an aspect ratio of 1.5;
Surface-coated spherical graphite 3: graphite formed by surface-coating the spherical graphite manufactured by Ito Graphite Co., Ltd. with magnesium carbonate, having a mean particle size of 8 μm and an aspect ratio of 1.5;
Surface-coated multilayer graphene: multilayer graphene surface-coated with magnesium carbonate and manufactured Ishihara Chemical Co., Ltd., having a width of 5-15 μm, a thickness of 10-20 nm, and an aspect ratio of 750;
Spherical graphite 1: non-surface-coated spherical graphite, manufactured by Ito Graphite Co., Ltd., having a mean particle size of 40 μm and an aspect ratio of 1.0;
Spherical graphite 2: non-surface-coated spherical graphite, manufactured by Ito Graphite Co., Ltd., having a mean particle size of 8 μm and an aspect ratio of 1.0;
Multilayer graphene: non-surface-coated multilayer graphene, manufactured by Ishihara Chemical Co., Ltd., having a width of 5-15 μm, a thickness of 10-20 nm, and an aspect ratio of 750;
Spherical alumina 1: polyhedral spherical alumina manufactured by Sumitomo Chemical Co., Ltd., having a mean particle size of 0.45 μm, product number AA04;
Spherical alumina 2: polyhedral spherical alumina manufactured by Sumitomo Chemical Co., Ltd., having a mean particle size of 5 μm, product number AAS;
Spherical alumina 3: spherical alumina manufactured by Denka Co., Ltd., having a mean particle size of 45 μm, product number DAW45;
Zinc oxide with large particle size: zinc oxide manufactured by Sakai Chemical Industry Co., Ltd., having a mean particle size of 5 μm, product number LPZINC5; and
Fine zinc oxide: zinc oxide manufactured by Sakai Chemical Industry Co., Ltd., having a mean particle size of 0.28 μm.

### 2. Evaluation

### (1) Viscosity

The viscosity of the thermal interface composition was measured under the condition including a rotational velocity of 0.3 rpm and a measuring duration of 200 seconds by using, as a measuring instrument, E type viscometer (model number: RC-215) manufactured by Toki Sangyo Co., Ltd.

### (2) Thermal Conductivity and Thermal Resistance

Each thermal interface composition (X) was sandwiched between two copper plates, each having a thickness of 1 mm, to make a sample. A pressing pressure of 1060 kPa was directly applied to the sample. In addition, the thickness of the thermal interface composition (X) in the sample was adjusted to any of the thicknesses shown in the following Tables 1 and 2. In this state, with the temperature at the upper surface of the sample maintained at 50° C. and the temperature at the lower surface thereof maintained at 20° C. under room temperature, the thermal diffusivity of the sample was measured in the direction in which the pressing pressure was applied using Dyn TIM Tester manufactured by Mentor Graphics. Based on the results, the thermal conductivity and thermal resistance of the sample were obtained in the direction in which the pressing pressure was applied.

### (3) Asker C Hardness

The Asker C hardness of the sample was measured using, as a measuring instrument, an Asker rubber hardness meter (durometer) type C manufactured by Kobunshi Keiki Co., Ltd.

TABLE 1

| | | | Examples | | | | | | | | |
|---|---|---|---|---|---|---|---|---|---|---|---|
| | | | 1 | 2 | 3 | 4 | 5 | 6 | 7 | 8 | 9 |
| Resin | Epoxy resin 1 | EPICLON 830S | 44 | 44 | — | — | — | — | — | — | — |
| Components | Epoxy resin 2 | YX7400 | — | — | 53.5 | 53.5 | — | — | — | — | — |
| (mass %) | Curing agent 1 | MEH-8000H | 35 | 35 | — | — | — | — | — | — | — |
| | Curing agent 2 | ELPC75 | — | — | 25.5 | 25.5 | — | — | — | — | — |
| | Curing accelerator | 2E4MZ | 1 | 1 | 1 | 1 | — | — | — | — | — |
| | Acrylic compound A | EXCEPARL L-MA | — | — | — | — | 68.5 | — | 68.5 | — | — |
| | Acrylic compound B | AMP-20GY | — | — | — | — | — | 68.5 | — | — | — |
| | Crosslinking agent | Karenz PE1 | — | — | — | — | 9.8 | 9.8 | 9.8 | — | — |
| | Radical initiator | VAm-110 | — | — | — | — | 1.7 | 1.7 | 1.7 | — | — |
| | Silicone resin | SE1885 | — | — | — | — | — | — | — | 75 | 75 |
| | Coupling agent A | KBM-503; | — | — | — | — | 20 | 20 | 20 | — | — |
| | Coupling agent B | Z-6583 | — | — | — | — | — | — | — | 25 | 25 |
| | Dispersant | MALIALIM | 20 | 20 | 20 | 20 | — | — | — | — | — |
| | | SC0505K | | | | | | | | | |
| Fillers | Carbon based | Surface-coated | 32.5 | 35 | — | — | — | — | — | — | — |
| (vol %) | materials (B) | spherical graphite 1 | | | | | | | | | |
| | | Surface-coated | — | — | 32 | 37 | 32 | 32 | 37 | 37 | 37 |
| | | spherical graphite 2 | | | | | | | | | |
| | | Surface-coated | | | 12 | — | 12 | 12 | — | — | — |
| | | spherical graphite 3 | | | | | | | | | |
| | | Surface-coated | — | — | — | 2 | — | — | 2 | 2 | 2 |
| | | multilayer graphene | | | | | | | | | |
| | Non-surface-coated | Spherical graphite 1 | — | — | — | — | — | — | — | — | — |
| | carbon-based | Spherical graphite 2 | — | — | — | — | — | — | — | — | — |
| | materials | Multilayer graphene | — | — | — | — | — | — | — | — | — |
| | Inorganic filler (C) | Spherical alumina 1: | — | — | 14 | 23 | 13 | 13 | 23 | 23 | 23 |
| | | AA04 | | | | | | | | | |
| | | Spherical alumina 2: | — | — | — | — | — | — | — | — | — |
| | | AA5 | | | | | | | | | |
| | | Spherical alumina 3: | — | — | — | — | — | — | — | — | — |
| | | DAW45 | | | | | | | | | |
| | | Zinc oxide with large | 16.25 | 17.5 | — | — | — | — | — | — | — |
| | | particlesize: | | | | | | | | | |
| | | LPZINC5 | | | | | | | | | |
| | | Fine zinc oxide | 16.25 | 17.5 | — | — | — | — | — | — | — |
| Viscosity (Pa · s), | | | 1136 | 4619 | 1045 | 3022 | 638 | 275 | 2188 | 855 | 2649 |
| 200s, 0.3 rpm | | | | | | | | | | | |
| Thickness (μm) | | | 400 | 400 | 400 | 400 | 400 | 400 | 400 | 400 | 400 |
| Thermal conductivity | | | 8.09 | 10.16 | 6.61 | 7.66 | 5.31 | 5.99 | 6.01 | 4 | 7.83 |
| (W/m · K) | | | | | | | | | | | |
| Thermal resistance | | | 1.17 | 1.07 | 1.28 | 1.2 | 1.33 | 1.25 | 1.19 | 1.37 | 1.08 |
| (K/W) | | | | | | | | | | | |
| Asker C hardness | | | 90 | 90 | 52 | 85 | 8 | 10 | 40 | 20 | 32 |

TABLE 2

| | | | Comparative examples | | | | | | |
|---|---|---|---|---|---|---|---|---|---|
| | | | 1 | 2 | 3 | 4 | 5 | 6 | 7 |
| Resin | Epoxy resin 1 | EPICLON 830S | 44 | — | — | — | — | — | — |
| Components | Epoxy resin 2 | YX7400 | — | 53.5 | 53.5 | — | — | — | — |
| (mass %) | Curing agent 1 | MEH-8000H | 35 | — | — | — | — | — | — |
| | Curing agent 2 | ELPC75 | — | 25.5 | 25.5 | — | — | — | — |
| | Curing accelerator | 2E4MZ | 1 | 1 | 1 | — | — | — | — |
| | Acrylic compound A | EXCEPARL L-MA | — | — | — | 68.5 | — | — | — |
| | Acrylic compound B | AMP-20GY | — | — | — | — | 68.5 | — | — |
| | Crosslinking agent | Karenz PE1 | — | — | — | 9.8 | 9.8 | — | — |
| | Radical initiator | VAm-110 | — | — | — | 1.7 | 1.7 | — | — |
| | Silicone resin | SE1885 | — | — | — | — | — | 75 | 75 |
| | Coupling agent A | KBM-503; | — | — | — | 20 | 20 | — | — |
| | Coupling agent B | Z-6583 | — | — | — | — | — | 25 | 25 |
| | Dispersant | MALIALIM SC0505K | 20 | 20 | 20 | — | — | — | — |
| Fillers | Carbon based | Surface-coated spherical graphite 1 | — | — | — | — | — | — | — |
| (vol %) | materials (B) | Surface-coated spherical graphite 2 | — | — | — | — | — | — | — |
| | | Surface-coated spherical graphite 3 | — | — | — | — | — | — | — |
| | | Surface-coated multilayer graphene | — | — | — | — | — | — | — |
| | Non-surface-coated | Spherical graphite 1 | 32.5 | — | — | 32 | 32 | 32 | 37 |
| | carbon-based | Spherical graphite 2 | — | — | — | 12 | 12 | 12 | — |
| | materials | Multilayer graphene | — | — | — | — | — | — | 2 |
| | Inorganic filler (C) | Spherical alumina 1: AA04 | — | — | — | 14 | 14 | 14 | 23 |
| | | Spherical alumina 2: AA5 | — | 18 | 21 | — | — | — | — |
| | | Spherical alumina 3: DAW45 | — | 42 | 49 | — | — | — | — |
| | | Zinc oxide with large particle size: | 16.25 | — | — | — | — | — | — |
| | | LPZINC5 | | | | | | | |
| | | Fine zinc oxide | 16.25 | — | — | — | — | — | — |
| Viscosity (Pa · s), 200s, 0.3 rpm | | | 5013 | 79 | 370 | 1331 | 4105 | 1203 | 3201 |
| Thickness (μm) | | | 400 | 400 | 400 | 400 | 400 | 400 | 400 |
| Thermal conductivity (W/m · K) | | | 9.62 | 3.44 | 5.03 | 4.97 | 5.94 | 4.11 | 8.21 |
| Thermal resistance (K/W) | | | 1.08 | 1.83 | 1.46 | 1.34 | 1.22 | 1.34 | 1.17 |
| Asker C hardness | | | 90 | 90 | 90 | 20 | 25 | — | — |

As can be seen from these results, when the epoxy resin was used, the viscosity increased in Comparative Example 1, compared to Examples 1 and 2. In addition, the thermal conductivity decreased in Comparative Examples 2 and 3 compared to Examples 3 and 4.

On the other hand, when the acrylic compound was used, the thermal conductivity decreased in Comparative Example 4 compared to Examples 5-7 and the viscosity increased in Comparative Example 5.

Also, when the silicone resin was used, the curability deteriorated so significantly in Comparative Examples 6 and 7, compared to Examples 8 and 9, that the Asker C hardness could not be measured.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A thermal interface composition comprising:
a resin (A); and
a carbon-based material (B) having a surface coated with an inorganic substance.

2. The thermal interface composition of claim 1, wherein
the carbon-based material (B) includes a first carbon-based material (B1) and a second carbon-based material (B2), and
an aspect ratio of the second carbon-based material (B2) is larger than an aspect ratio of the first carbon-based material (B1).

3. The thermal interface composition of claim 2, wherein
the aspect ratio of the second carbon-based material (B2) is equal to or greater than 3 and equal to or less than 1200.

4. The thermal interface composition of claim 2, wherein
the first carbon-based material (B1) includes a spherical graphite.

5. The thermal interface composition of claim 2, wherein
the second carbon-based material (B2) includes at least one selected from the group consisting of a plate graphite, a single-layer graphene, a multilayer graphene, a multilayer carbon nanotube, and a single-layer carbon nanotube.

6. The thermal interface composition of claim 4, wherein
the second carbon-based material (B2) includes at least one selected from the group consisting of a plate graphite, a single-layer graphene, a multilayer graphene, a multilayer carbon nanotube, and a single-layer carbon nanotube.

7. The thermal interface composition of claim 2, wherein
proportion by volume of the first carbon-based material (B1) to a total of the thermal interface composition is equal to or greater than 1% by volume and equal to or less than 90% by volume.

8. The thermal interface composition of claim 2, wherein
proportion by volume of the second carbon-based material (B2) to a total of the thermal interface composition is equal to or greater than 0.1% by volume and equal to or less than 30% by volume.

9. The thermal interface composition of claim 7, wherein
proportion by volume of the second carbon-based material (B2) to a total of the thermal interface composition is equal to or greater than 0.1% by volume and equal to or less than 30% by volume.

10. The thermal interface composition of claim 2, wherein
proportion of the first carbon-based material (B1) to a total of the thermal interface composition is larger than proportion of the second carbon-based material (B2) to the total of the thermal interface composition.

11. The thermal interface composition of claim 7, wherein
proportion of the first carbon-based material (B1) to a total of the thermal interface composition is larger than proportion of the second carbon-based material (B2) to the total of the thermal interface composition.

12. The thermal interface composition of claim 8, wherein
proportion of the first carbon-based material (B1) to a total of the thermal interface composition is larger than proportion of the second carbon-based material (B2) to the total of the thermal interface composition.

13. The thermal interface composition of claim 9, wherein
proportion of the first carbon-based material (B1) to a total of the thermal interface composition is larger than proportion of the second carbon-based material (B2) to the total of the thermal interface composition.

14. The thermal interface composition of claim 1, wherein
the resin (A) includes at least one selected from the group consisting of epoxy resins, acrylic compounds, and silicone resins.

15. The thermal interface composition of claim 4, wherein
the resin (A) includes at least one selected from the group consisting of epoxy resins, acrylic compounds, and silicone resins.

16. The thermal interface composition of claim 5, wherein
the resin (A) includes at least one selected from the group consisting of epoxy resins, acrylic compounds, and silicone resins.

17. The thermal interface composition of claim 6, wherein
the resin (A) includes at least one selected from the group consisting of epoxy resins, acrylic compounds, and silicone resins.

18. A thermal interface material formed by molding the thermal interface composition of claim 1 into a film shape or a sheet shape.
